(19) United States
(12) Patent Application Publication
(10) Pub. No.: US 2008/0180230 A1
(43) Pub. Date: Jul. 31, 2008

(54) Electronic horn having simulated start and end sounds

(76) Inventor: Daniel Eugene Zimmermann, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/700,177

(22) Filed: Jan. 31, 2007

(51) Int. Cl. G08B 3/10

(52) U.S. Cl. 340/384.3; 340/384.7

(57) ABSTRACT

An electronic horn for a vehicle is disclosed. The electronic horn may have a speaker, a primary power source, and a secondary power source. The primary power source may be configured to power the speaker during normal operation of the horn. The secondary power source may be configured to power the speaker during another horn operation.

### TECHNICAL FIELD

This disclosure relates generally to a horn and, more particularly, to an electronic horn having a simulated start and end.

### BACKGROUND

Horns are common in many types of vehicles, but can be particularly important in industrial vehicles such as fork lifts, construction equipment, transportation vehicles, and other types of heavy equipment. A horn is particularly important in these types of vehicles because the vehicles often have structures that obscure the driver's view, making it difficult for the driver to see pedestrians and other obstacles in the path of the vehicles. In addition, many of these vehicles are operated within enclosed facilities such as warehouses or in congested work areas such as mine sites, where a pedestrian could walk around a blind corner and into the path of the vehicle. In such a case, neither the pedestrian nor the vehicle's operator may be adequately forewarned of the other's presence to prevent an accident. Additionally, these industrial vehicles are often used to carry heavy loads that could be unstable or easily disrupted further increasing the likelihood of injury or damage when unexpected stops are required to avoid pedestrians.

A horn is an important feature on an industrial vehicle because it enables the operator to warn people nearby to stay clear of the vehicle. In addition, the horn can also be used to signal other machine operators in the same vicinity of a need such as when a truck is in position and ready for loading, or completion of a task such as when an excavator or wheel loader has completed the loading process. Because of these many applications, the horn in an industrial vehicle is used much more often than a horn in a typical passenger car.

In the past, horns on industrial vehicles were air powered and produced a unique sound similar to that of a musical horn such as a trumpet or a tuba. However, this type of horn suffered from durability problems, especially when exposed to the harsh environments in which many industrial vehicles operate. As a result, the air horn required frequent servicing at significant cost and down time.

An attempt at addressing the durability problem of the air powered horn is described in U.S. Pat. No. 6,489,885 (the '885 patent) issued to Solow on Dec. 3, 2002. Specifically, the '885 patent describes a vehicle horn having electronic data representing audio horn signals recorded in a memory. The horn includes a digital counter responsive to clock signals from an oscillator to sequentially read the horn audio data from the memory, provide the data to a D/A converter, and then output audio signal to a speaker for broadcast. In a preferred arrangement, there is provided an amplifier for amplifying the audio signal.

If the horn of the '885 patent is activated for a sufficiently long period of time, the counter continues running and the read-out repeatedly cycles through the assigned memory space. There is no concern from where the count starts or ends, or what portion of the horn sound is initialed at the start of the readout. Since a horn sound is fundamentally repetitive, it can be replicated by reading out the memory space repeatedly. Because no mechanical parts or relays are included and subject to wear, the horn of the '885 patent has high reliability, even with frequent use.

Although the horn of the '885 patent may have improved reliability, as compared to previous air powered horns, it may lack the pleasing musical sound of the trumpet or tuba. Specifically, because no concern is given to what portion of the horn sound is initialed at the start or end of the read out, the simulated sound from the horn of the '885 patent may be substantially different from that of the customary air powered horns. In addition, instead of a single continuous blast from the horn, as was customary with previous air powered horns, the horn of the '885 patent merely sounds repetitively. This repeating sequence of horn sounding may be displeasing to some users.

The electronic horn of the present disclosure is directed towards overcoming one or more of the problems as set forth above.

### SUMMARY OF THE INVENTION

In accordance with one aspect, the present disclosure is directed toward an electronic horn. The electronic horn may include a speaker, a primary power source, and a secondary power source. The primary power source may be configured to power the speaker during normal operation of the horn. The secondary power source may be configured to power the speaker during another horn operation.

According to another aspect, the present disclosure is directed toward a method of electronically simulating the sound of an air horn. The method may include receiving a first operator input indicative of a desired start of horn sounding, and broadcasting a startup sound in response to the first operator input. The method may also include broadcasting a mid-portion sound following completion of the startup sound. The method may further include receiving a second operator input indicative of a desired end of horn sounding, and ceasing to broadcast the mid-portion sound in response to the second operator input.

### BRIEF DESCRIPTION OF THE DRAWINGS

FIG. 1 is a schematic illustration of an exemplary disclosed electronic horn system;

FIG. 2 is a schematic illustration of an exemplary horn electronics configuration of the electronic horn system of FIG. 1; and

FIG. 3 is a flowchart depicting an exemplary disclosed method of operating the horn electronics of FIG. 2.

### DETAILED DESCRIPTION

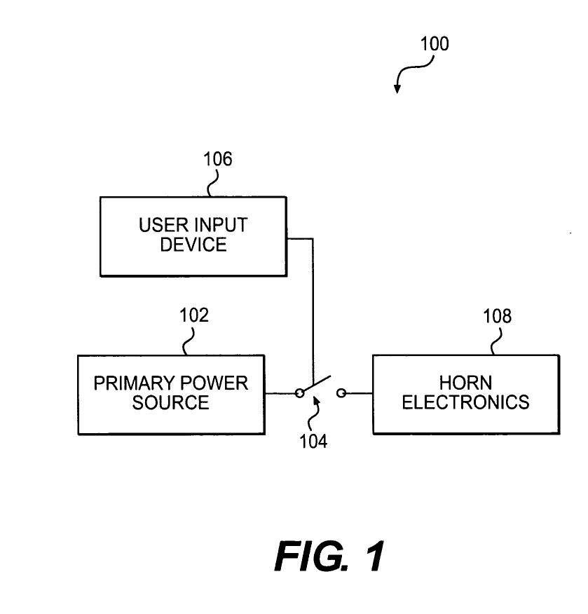

FIG. 1 illustrates an electronic horn system 100 including a primary power source 102 and a switch 104 communicatively coupled with a user input device 106, switch 104 selectively connecting primary power source 102 to a set of electronics referred to as horn electronics 108. Electronic horn system 100 may be associated with a vehicle such as an automobile, a dozer, a loader, an excavator, or any other machine known in the art. The components of electronic horn system 100 may generally cooperate to direct power from primary power source 102 to horn electronics 108.

Primary power source 102 may produce and/or store power, and may embody a battery, an engine, a fuel cell, a power storage device, or any other source of power known in the art. For example, primary power source 102 may embody a combustion engine, such as an engine of an associated machine. Alternatively, primary power source 102 may embody a vehicle battery, such as a battery of an associated machine. It is contemplated, however, that primary power source 102 may embody an independent source of power specific to electronic horn system 100. Primary power source 102 may deliver power to switch 104.

Switch 104 may receive power from primary power source 102 and selectively deliver power to horn electronics 108. Switch 104 may be electronically or mechanically moveable from an open position, at which power is blocked from horn electronics 108, to a closed position, at which power is delivered from switch 104 to horn electronics 108. The position of switch 104 may be determined at least in part by user input device 106. One skilled in the art will appreciate that switch 104 may alternatively connect horn electronics 108 to ground.

User input device 106 may be manipulated by a user to move switch 104 between the open position and the closed position. For example, user input device 106 may embody an electronic button that, when depressed, delivers a signal to switch 104 indicating that switch 104 should move to the closed position. User input device 106 may similarly indicate that switch 104 should return to the open position when the electronic button is released by delivering an appropriate signal or by cancelling any previously sent signals. That is, switch 104 may interpret an absence of a signal from user input device 106 as an indication that it should be in the open position. In another example, user input device 106 may be a mechanical button that, when depressed, drives switch 104 to be in the closed position, and when released allows switch 104 to move to the open position. It is contemplated that user input device 106 may alternatively indicate a change of state of switch 104 each time it is pressed. That is, a single press of user input device 106 may direct switch 104 to change state from open to closed or from closed to open, depending on the state of switch 104 at the time user input device 106 is manipulated. It is further contemplated that user input device 106 may directly move switch 104 between the open and closed positions. For example, switch 104 may be a toggle type switch moveable from a closed position to an open position when a user operates a two-position joystick or sliding button. It is also contemplated that user input device 106 may be any other type of input device that can manipulate the position of switch 104. When user input device 106 moves switch 104 the closed position, this movement may indicate that the user desires power be supplied from primary power source 102 to horn electronics 108.

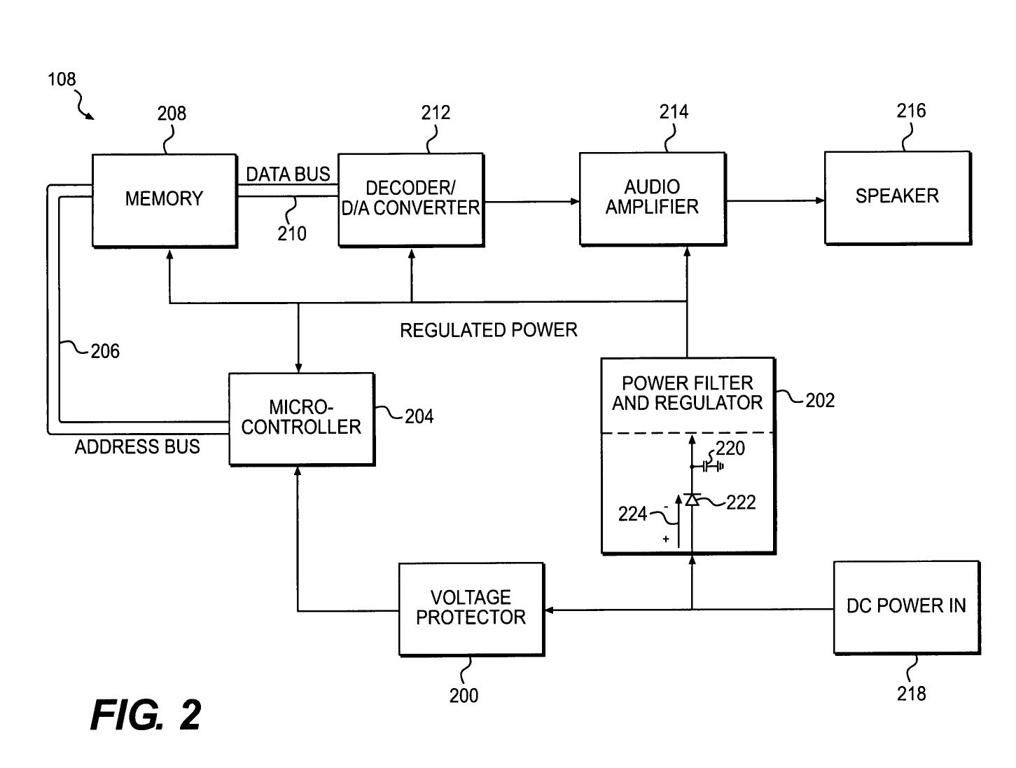

As illustrated in FIG. 2, horn electronics 108 may include components to facilitate the electronic production of an audible horn sound, such as, for example, a voltage protector 200, a power filter and regulator 202, a microcontroller 204, an address bus 206, a memory device 208 with a predetermined size and number of memory locations with corresponding memory addresses, a data bus 210, a decoder and/or digital-to-analog converter (“decoder/D/A converter” 212), an audio amplifier 214, and a speaker 216. It is contemplated that horn electronics 108 may include other electrical and/or mechanical components to facilitate the electronic production of a horn sound. It is further contemplated that horn electronics 108, in whole or in part, may be included as part of another electronic system such as, for example, an engine control system or an electronic control module. Horn electronics 108 may receive a direct current input (“DC input” 218) from switch 104. That is, when switch 104 is in the open position, horn electronics 108 may receive a “low” DC input 218 substantially equal to 0V or may not receive any DC input 218, and when switch 104 is in the closed position, horn electronics 108 may receive a “high” DC input 218 from primary power source 102.

Voltage protector 200 may receive power from DC input 218 and supply power to microcontroller 204. More specifically, voltage protector 200 may include components that limit the voltage provided by DC input 218 to within a predetermined range of acceptable power values for microcontroller 204. Voltage protector 200 may include, for example, one or more fuses, a metal oxide varistor, a zener diode, and a capacitor. Although FIG. 1 shows voltage protector 200 in series with microcontroller 204, voltage protector 200 may alternatively embody an inductor connected in parallel with microcontroller 204. Voltage protector 200 may selectively deliver a control signal to microcontroller 204. Specifically, when DC input 218 is “high,” voltage protector 200 may accept the signal from DC input 218, limit the voltage to within a predetermined range, and deliver the limited “high” voltage signal to microcontroller 204. Further, when DC input 218 is “low,” voltage protector 200 may not deliver any signal to microcontroller 204.

Power filter and regulator 202 may also receive power from DC input 218 and supply power to microcontroller 204, memory, decoder/D/A converter 212, and audio amplifier 214. More specifically, power filter and regulator 202 may include components that limit the effect of signal noise on power supplied to horn electronics 108. Power filter and regulator 202 may include, for example, one or more transistors, and a zener diode. It is contemplated that power filter and regulator 202 may embody any other type of DC-in/DC-out regulator such as, for example, a switching-mode power supply. When DC input 218 is “high,” power filter and regulator 202 may receive power from DC input 218, limit the effect of signal noise on the power, and deliver the noise-reduced power to microcontroller 204, memory, decoder/D/A converter 212, and audio amplifier 214. It is contemplated that power filter and regulator 202 may additionally provide power to other components.

Power filter and regulator 202 may additionally include a secondary power source such as a capacitor 220 that supplies power to microcontroller 204, memory device 208, decoder/D/A converter 212, and audio amplifier 214 when DC input 218 is “low.” For example, capacitor 220 may be charged by the power received from DC input 218 when DC input 218 is “high.” Capacitor 220 may take, for example, a fraction of a second to fully charge. Capacitor 220 may then discharge when DC input 218 is “low” by providing power to microcontroller 204, memory, decoder/D/A converter 212, and audio amplifier 214. The amount of time required to fully discharge capacitor 220 from a fully charged state may be at least the amount of time required to play an end portion of a horn sound. The flow of power provided by capacitor 220 may be blocked from DC input 218 and voltage protector 200 by a diode 222 located between capacitor 220 and DC input 218 and voltage protector 200. That is, diode 222 may be oriented within power filter and regulator 202 such that voltage is allowed to drop in only the direction indicated by an arrow 224. It is contemplated that the secondary power source may alternatively embody any other charge-holding or power storage device such as, for example, a battery.

Microcontroller 204 may embody a single microprocessor or multiple microprocessors that include a means for accessing memory locations in memory device 208 in response to the control signal delivered by voltage protector 200. For example, microcontroller 204 may include a memory, a secondary storage device, a clock, and a processor, such as a central processing unit or any other means for accessing memory locations in memory device 208 in response to the signal generated by voltage protector 200. Numerous commercially available microprocessors can be configured to perform the functions of microcontroller 204. It should be appreciated that microcontroller 204 could readily embody a general power source microprocessor capable of controlling numerous power source functions. Various other known circuits may be associated with microcontroller 204, including power supply circuitry, signal-conditioning circuitry, solenoid driver circuitry, communication circuitry, and other appropriate circuitry. It should also be appreciated that microcontroller 204 may include one or more of an application-specific integrated circuit (ASIC), a field-programmable gate array (FPGA), a computer system, and a logic circuit, configured to allow microcontroller 204 to function in accordance with the present disclosure. Thus, the memory of microcontroller 204 may embody, for example, the flash memory of an ASIC, flip-flops in an FPGA, the random access memory of a computer system, or a memory circuit contained in a logic circuit. Microcontroller 204 may be further communicatively coupled with an external computer system, instead of or in addition to including a computer system.

Microcontroller 204 may receive power from power filter and regulator 202, and a control signal from voltage protector 200. Microcontroller 204 may also deliver memory address locations to address bus 206. More specifically, microcontroller 204 may receive power from power filter and regulator 202 while DC input 218 is “high,” and for a duration of time substantially immediately after DC input 218 changes to “low.” The duration of time may equal, for example, the duration of the discharge of capacitor 220. Microcontroller 204 may receive the control signal from voltage protector 200 only when DC input 218 is “high,” as disclosed above. Microcontroller 204 may deliver memory addresses to address bus 206 corresponding to memory locations of memory device 208. Microcontroller 204 may deliver these memory addresses only while it receives power from power filter and regulator 202. Further, the memory of microcontroller 204 may store a plurality of memory addresses corresponding to specific memory locations of memory device 208 such as, for example, the first and last memory locations of sampled audio waveforms stored in memory device 208.

Address bus 206 may embody a set of wires that logically connect microcontroller 204 to memory device 208. The number of wires of address bus 206 may be determined, at least in part, by the number of memory addresses required to access the memory locations of memory device 208. For example, if memory device 208 includes 2N memory locations, address bus 206 of N wires may be utilized to address each of the 2N memory locations.

Memory device 208 may embody any data storage device. For example, memory device 208 may embody any of non-volatile random access memory (a.k.a. NVRAM), flash memory, or read-only memory (a.k.a. ROM) such as programmable read-only memory (a.k.a. PROM), erasable programmable read-only memory (a.k.a. EPROM), and electronically erasable read-only memory (a.k.a. EEPROM). It is contemplated that memory device 208 may alternatively embody a volatile data storage device with an independent power source. The memory locations of memory device 208 may each store an audio sample such that concurrent blocks of memory locations store consecutive audio samples of continuous audio waveforms. For example, a first block of memory locations may store audio samples of the beginning of an air horn blast (the “horn startup sound”), a second block of memory locations may store audio samples of the middle of a sustained air horn blast (the “horn mid-portion sound”), and a third block of memory locations may store audio samples of the end of an air horn blast (the “horn shutoff sound”). Each sampled waveform stored in blocks of the memory locations of memory device 208 may be sampled at a predetermined rate. It is contemplated that the sampled waveforms stored in memory device 208 may also be digitally encoded. Memory device 208 may receive a memory location address from address bus 206, and deliver the contents of the memory location indicated by the address to data bus 210. It is contemplated that memory device 208 may include an independent processor to at least partially control its functionality, if desired.

Data bus 210 may embody a set of wires that logically connect memory device 208 to decoder/D/A converter 212. The number of wires of data bus 210 may be determined, at least in part, by the size in bits of the memory locations of memory device 208. For example, if the memory locations of memory device 208 are M bits large, data bus 210 of M wires may be utilized to transmit the contents of a memory location to decoder/D/A converter 212.

Decoder/D/A converter 212 may include components that receive a sequence of discrete data signals from data bus 210 and deliver a low-power analog audio signal to audio amplifier 214. For example, decoder/D/A converter 212 may include an audio codec capable of decoding encoded audio signals and outputting a corresponding digital signal, and a D/A converter such as, for example, a pulse width modulator. If the audio data stored in memory device 208 are encoded, decoder/D/A converter 212 may receive the data signals from data bus 210 and decode each data signal. The unencoded data signals may then be converted to an analog audio signal, and delivered to audio amplifier 214. It is contemplated that the audio data stored in memory device 208 may not be encoded, and that decoder/D/A converter 212 may omit the audio codec and simply convert the data signals from data bus 210 to an analog audio signal, and deliver the analog audio signal to audio amplifier 214.

Audio amplifier 214 may receive an analog audio signal and deliver an amplified version of the analog audio signal. More specifically, audio amplifier 214 may receive a low-power analog audio signal and amplify it to be suitable to drive a speaker 216 at a clearly audible volume. It is contemplated that audio amplifier 214 may embody a multi-stage amplifier with a pre-amp stage that first amplifies the low-power signal to line-level, and a second amplifier stage that amplifies the line-level signal to be suitable to drive a speaker 216 at a clearly audible volume. It is further contemplated that audio amplifier 214 may include other components to facilitate the conversion of a low-power analog audio signal to an analog audio signal suitable to drive a speaker 216 at a clearly audible volume, such as, for example, a negative feedback loop to reduce signal noise.

Speaker 216 may receive an analog audio signal and produce sounds corresponding to the signal. Speaker 216 may embody a woofer, mid-range speaker 216, tweeter, or combination thereof.

### INDUSTRIAL APPLICABILITY

The disclosed electronic horn system may be applicable to any vehicle or work machine that utilizes a horn or other audio alert device. The disclosed electronic horn system may provide a natural-sounding horn without the reliability and durability problems of traditional air-powered horns. Operation of electronic horn system 100 will now be described.

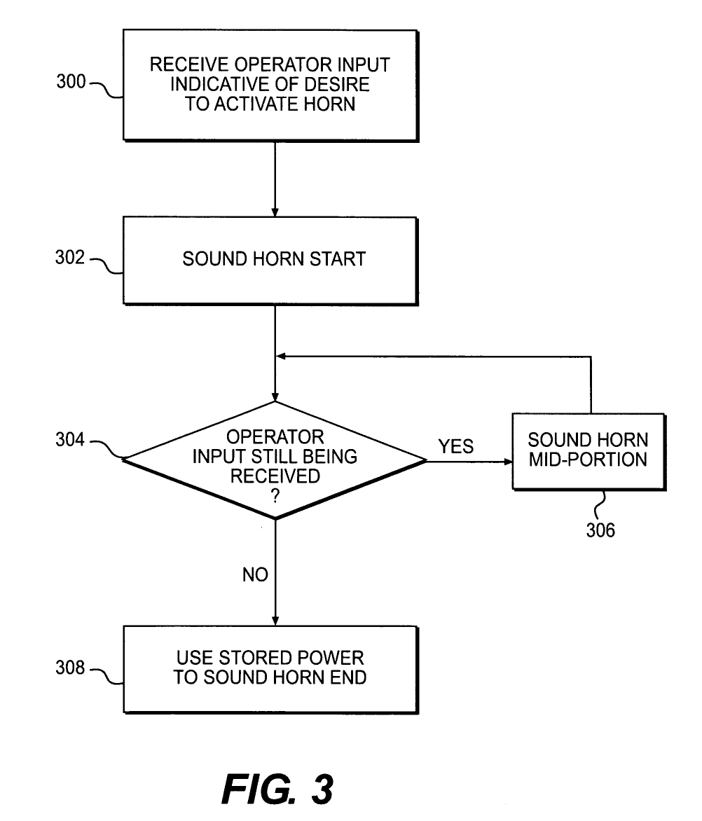

Primary power source 102 may produce power during all operation of an associated vehicle or work machine. Primary power source 102 may supply power necessary to operate horn electronics 108 to produce a horn alert sound. FIG. 3 illustrates an exemplary process of playing a horn alert sound.

When an operator of the vehicle or work machine desires to activate a horn alert sound, the operator may operate user input device 106 by, for example, depressing a button (Step 300). This indication from the operator may result in moving switch 104 to the closed position, thus providing power from primary power source 102 to DC input 218 of horn electronics 108. The power signal from DC input 218 may then be provided both to voltage protector 200 and power filter and regulator 202. Voltage protector 200 may limit the power signal to within a predetermined limit for input to microcontroller 204 while power filter and regulator 202 may reduce noise affecting the power signal and deliver the noise-reduced power signal to microcontroller 204, memory device 208, decoder/D/A converter 212, and audio amplifier 214. Further, the power signal from DC input 218 may charge capacitor 220.

Once microcontroller 204 has been powered by the signal from power filter and regulator 202, and has received the voltage-limited control signal from voltage protector 200, microcontroller 204 may access its own memory to find the memory location address of the first audio data sample of the horn startup sound stored in memory device 208 (Step 302). Microcontroller 204 may then deliver the memory location address to address bus 206. The clock of microcontroller 204 may run in parallel with this process. The clock may indicate a passage of time since the last memory location address was delivered to address bus 206 is equal to the time between the samples of audio stored in memory device 208, and microcontroller 204 may respond to each indication by delivering the next memory location address of the horn startup sound to address bus 206. For example, if the sampling rate of the audio stored in memory device 208 is 44 kHz and the clock runs at 44 kHz, then on each clock cycle, microcontroller 204 may deliver the memory location address of each successive horn startup sound sample. More specifically, if the first audio data sample of the horn startup sound is stored at the memory location addressed by 0x00, microcontroller 204 may deliver 0x00 to address bus 206 to begin horn startup sound, and on each subsequent clock cycle, microcontroller 204 may deliver 0x01, 0x02, etc., until the memory location address of the last audio sample of the horn startup sound has been delivered to address bus 206.

As each address is delivered to address bus 206, address bus 206 may deliver the address to memory device 208. As each memory address is received by memory device 208, memory device 208 may access the memory in the location addressed by the memory address and deliver the memory address to decoder/D/A converter 212 via data bus 210. Decoder/D/A converter 212 may then convert the sequence of discrete audio samples from data bus 210 to a continuous low-power analog audio signal. This low-power analog signal may then be delivered to audio amplifier 214 where it may be amplified and subsequently delivered to speaker 216, where it may be audibly broadcast.

Once microcontroller 204 has delivered the final memory location address of the horn startup sound, microcontroller 204 may check whether the control signal from voltage protector 200 is still being received (Step 304). If the signal is still being received, microcontroller 204 may initiate the sounding of the horn mid-portion sound by delivering the first memory location address of the horn mid-portion sound samples stored in memory device 208 in the same manner as discussed above for the horn startup sound (Step 306). It is contemplated that microcontroller 204 may use a counter to cycle through the memory location addresses of the horn mid-portion sound samples and that microcontroller 204 may deliver any of the memory location addresses of the horn mid-portion sound samples as the first memory address location of the horn mid-portion sound samples.

On each successive clock cycle, microcontroller 204 may check whether the control signal from voltage protector 200 is still being received (Step 304). As long as the control signal from voltage protector 200 is being received, microcontroller 204 may deliver the next consecutive memory location address of the horn mid-portion sound samples to address bus 206 (Step 306). If the last memory location address of the horn mid-portion sound is reached, microcontroller 204 may simply reset its counter to the first memory location address of the horn mid-portion sound samples stored in memory device 208. During the delivery of memory location addresses of the horn mid-portion sound samples, the functionality of address bus 206, memory device 208, data bus 210, decoder/D/A controller, audio amplifier 214, and speaker 216 may remain as they were described above such that the horn mid-portion sound is audibly broadcast.

When the operator indicates that the horn sound should end (e.g. by releasing user input device 106), switch 104 may be moved to the open position, as disclosed above. Primary power source 102 may then be separated from horn electronics 108, thus removing the signal at DC input 218. Once the signal at DC input 218 has been removed, capacitor 220 may begin to discharge while providing power to microcontroller 204, memory, decoder/D/A converter 212, and audio amplifier 214. Further, microcontroller 204 may determine that the control signal from voltage protector 200 is no longer being received at Step 304, and proceed to begin delivering the memory location addresses of the horn shutoff sound samples (Step 308). More specifically, microcontroller 204 may first deliver the first memory location address of the horn shutoff sound samples to address bus 206, and proceed to deliver each subsequent memory location address of the horn shutoff sound samples to address bus 206 until the final horn shutoff sound sample memory location address has been delivered. During the delivery of memory location addresses of the horn shutoff sound samples, the functionality of address bus 206, memory device 208, data bus 210, decoder/D/A controller, audio amplifier 214, and speaker 216 may remain as they were described above such that the horn shutoff sound is audibly broadcast.

The disclosed electronic horn system and method may provide a natural-sounding musical sound similar to that of previous air powered horns. More specifically, because the disclosed electronic horn system may ensure that the distinct horn startup and horn shutoff sounds are played every time the horn is activated, the resulting sound may provide a digitally-stored natural horn sound. Further, because the disclosed electronic horn system may be implemented entirely as a solid-state system without moving parts, the disclosed electronic horn system may provide improved reliability, as compared to previous air powered horns.

It will be apparent to those skilled in the art that various modifications and variations can be made to the electronic horn system of the present disclosure. Other embodiments of the method and system will be apparent to those skilled in the art from consideration of the specification and practice of the electronic horn disclosed herein. It is intended that the specification and examples be considered as exemplary only, with a true scope of the disclosure being indicated by the following claims and their equivalents.

What is claimed is:

1. An electronic horn, comprising:
a speaker;
a primary power source configured to power the speaker during normal operation of the horn; and
a secondary power source configured to power the speaker during another horn operation.

2. The electronic horn of claim 1, further including a controller in communication with the speaker to broadcast a startup sound, a mid-portion sound, and a shutoff sound in response to operator input.

3. The electronic horn of claim 2, wherein the controller is configured to initiate the startup sound when the operator indicates a desired start of horn sounding.

4. The electronic horn of claim 3, wherein the mid-portion sound is broadcast after completion of the startup sound.

5. The electronic horn of claim 4, wherein the mid-portion sound continues until the operator indicates a desired end of horn sounding.

6. The electronic horn of claim 5, wherein the shutoff sound is broadcast after completion of the mid-portion sound.

7. The electronic horn of claim 6, wherein the another horn operation includes broadcasting of the shutoff sound.

8. The electronic horn of claim 1, wherein the primary power source is a vehicle battery.

9. The electronic horn of claim 8, wherein the secondary power source is an auxiliary power storage device.

10. The electronic horn of claim 9, wherein the auxiliary power storage device is a capacitor.

11. The electronic horn of claim 9, wherein the auxiliary power storage device is a battery.

12. The electronic horn of claim 1, further including:
a memory having stored therein the startup sound, mid-portion sound, and shutoff sound; and
an amplifier associated with the speaker and configured to amplify signals from the controller.

13. The electronic horn of claim 12, further including a decoder communicatively coupled between the controller and the amplifier.

14. An electronic horn, comprising:
a speaker;
a main power source configured to power the speaker during normal operation of the horn; and
a controller in communication with the speaker to broadcast a startup sound, a mid-portion sound, and a shutoff sound in response to operator input, wherein
the controller is configured to initiate the startup sound when the operator indicates a desired start of horn sounding;
the mid-portion sound is broadcast after completion of the startup sound and continues until the operator indicates a desired end of horn sounding; and
the shutoff sound is broadcast after completion of the mid-portion sound.

15. The electronic horn of claim 14, further including:
a memory having stored therein the startup sound, mid-portion sound, and shutoff sound; and
an amplifier associated with the speaker and configured to amplify signals from the controller.

16. The electronic horn of claim 15, further including a decoder communicatively coupled between the controller and the amplifier.

17. A method of electronically simulating the sound of an air horn, comprising:
receiving a first operator input indicative of a desired start of horn sounding;
broadcasting a startup sound in response to the first operator input;
broadcasting a mid-portion sound following completion of the startup sound;
receiving a second operator input indicative of a desired end of horn sounding; and
ceasing to broadcast any horn sounds in response to the second operator input.

18. The method of claim 17, further including broadcasting a shutoff sound following completion of the mid-portion sound.

19. The method of claim 18, wherein:
the startup and mid-portion sounds are powered by a primary power source; and
the shutoff sound is powered by secondary power source.

20. The method of claim 19, wherein power supply from the primary power source is discontinued in response to the second operator input.
